(19) United States
(12) Patent Application Publication
(10) Pub. No.: US 2026/0212303 A1
(43) Pub. Date: Jul. 23, 2026

(54) SYSTEMS AND METHODS OF MANAGING AN ENTERPRISE ASSET

(71) Applicant: Sudheer Sajja, Peoria, IL (US)

(72) Inventor: Sudheer Sajja, Peoria, IL (US)

(21) Appl. No.: 19/035,475

(22) Filed: Jan. 23, 2025

(51) Int. Cl. G06Q 10/0639; G06Q 10/0631

(52) U.S. Cl. CPC G06Q 10/0639; G06Q 10/06311

(57) ABSTRACT

The present disclosure provides a method of managing an enterprise asset. Further, the method may include receiving, using a communication device, an asset data from one or more enterprise devices associated with an enterprise. Further, the asset data may be associated with the enterprise asset. Further, the one or more enterprise devices may be associated with the enterprise asset. Further, the method may include analyzing, using a processing device, the asset data. Further, the method may include generating, using the processing device, an asset management data based on the analyzing. Further, the method may include transmitting, using the communication device, the asset management data to the one or more enterprise devices.

### FIELD OF DISCLOSURE

The present disclosure relates to the field of data processing. More particularly, the present disclosure relates to methods and systems for managing an enterprise asset.

### BACKGROUND

Electronic assets are the backbones of every organization they serve. Businesses often suffer from productivity constraints arising from an inability to effectively manage the output and overall health of their assets, more particularly, their electronic assets. As a result, businesses with a large fleet of electronic assets end up coming short in optimizing the electronic assets they own. Asset management systems come in handy for businesses seeking to achieve optimal returns from the operation of all their assets. An effective asset management system could aid a business in operating and maintaining the digital assets they own. This is vital to the success of a lot of businesses, particularly in the competitive landscape which most businesses operate.

In today’s business world, there is a core need for asset management systems that allow for efficient management and optimization of a business’ electronic assets. Businesses can save a lot of operational costs through the use of a proficient asset management system.

Currently, the methods and systems for managing enterprise assets are deficient in several ways. For example, existing techniques of identifying issues with enterprise assets are not reliable. For example, technicians are required to be physically present near the enterprise assets in order to manage the enterprise assets.

Therefore, there is a need for improved methods and systems for managing an enterprise asset.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

The present disclosure provides a method of managing an enterprise asset. Further, the method may include receiving, using a communication device, an asset data from one or more enterprise devices associated with an enterprise. Further, the asset data may be associated with the enterprise asset. Further, the one or more enterprise devices may be associated with the enterprise asset. Further, the method may include analyzing, using a processing device, the asset data. Further, the method may include generating, using the processing device, an asset management data based on the analyzing. Further, the method may include transmitting, using the communication device, the asset management data to the one or more enterprise devices.

The present disclosure provides a system of managing an enterprise asset. Further, the system may include a communication device. Further, the communication device may be configured for receiving an asset data from the one or more enterprise devices associated with an enterprise. Further, the asset data may be associated with the enterprise asset. Further, the one or more enterprise devices may be associated with the enterprise asset. Further, the communication device may be configured for transmitting an asset management data to the at least one enterprise device. Further, the system may include a processing device. Further, the processing device may be configured for analyzing the asset data. Further, the processing device may be configured for generating the asset management data based on the analyzing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of managing an enterprise asset, in accordance with some embodiments.

FIG. 4 illustrates a block diagram of a system 400 of managing an enterprise asset, in accordance with some embodiments.

FIG. 5 is a representation of a graphical user interface of the log-in page of the asset management system, in accordance with some embodiments.

FIG. 6. is a graphical user interface illustrating how technicians with access to accounts of different companies may be able to switch access between different organizations they belong to and access the asset management systems of these companies, in accordance with some embodiments.

FIG. 7 represents a depiction of a graphical user interface of a user management page of the disclosed asset management system, in accordance with some embodiments.

FIG. 8 represents a depiction of a graphical user interface of a task page of the disclosed asset management system, in accordance with some embodiments.

FIG. 9 depicts another representation of a graphical user interface of a fleet page of the disclosed asset management system, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, a mini-computer, a micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### OVERVIEW

The present disclosure provides methods and systems for facilitating managing of enterprise assets. In some embodiments, the invention may be a system for remotely managing electronic assets, providing bi-directional communication to receive real-time performance data, send commands, compare performance against historical data, and trigger alerts and actions based on configurable thresholds. For example, using a door sensor, a weather feed and a floor cleaning bot, it can automate the floor cleaning robot to clean a retail store entryway after 100 door openings on a rainy day while on a sunny day wait until 300 openings.

In some embodiments, the invention utilizes APIs from an asset manufacturer or installs software on an electronic asset to transmit data to its database when no API is available. The data may be processed through business rules to identify deviations from ideal operating conditions and may be then sent via web sockets to update the invention’s graphical user interface. Any abnormal data can trigger alerts via SMS, email, in-app notifications, or initiate commands to the source asset or other assets owned by the managing client.

In some embodiments, the invention may include the following components:

The on-asset data transmission software

The data pipeline that receives data

The API that sends data.

The rules engine that processes the data

The database to persist the data

The real-time component that sends to the User Interface

The user interface that presents the data

The components are hosted in the cloud with the exception of the ‘on asset’ component, they communicate via HTTPS, Web Sockets, MQTT and Azure Storage Queues.

Further, in some embodiments, the method for managing the enterprise assets may include:

1. Receive data from the asset.

2. Process data through the rules.

3. Send any alerts.

4. Trigger any events.

5. Broadcast the data to the user interface.

6. Persist the data on the system

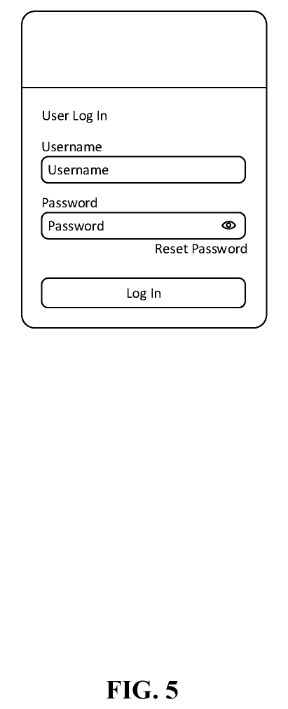

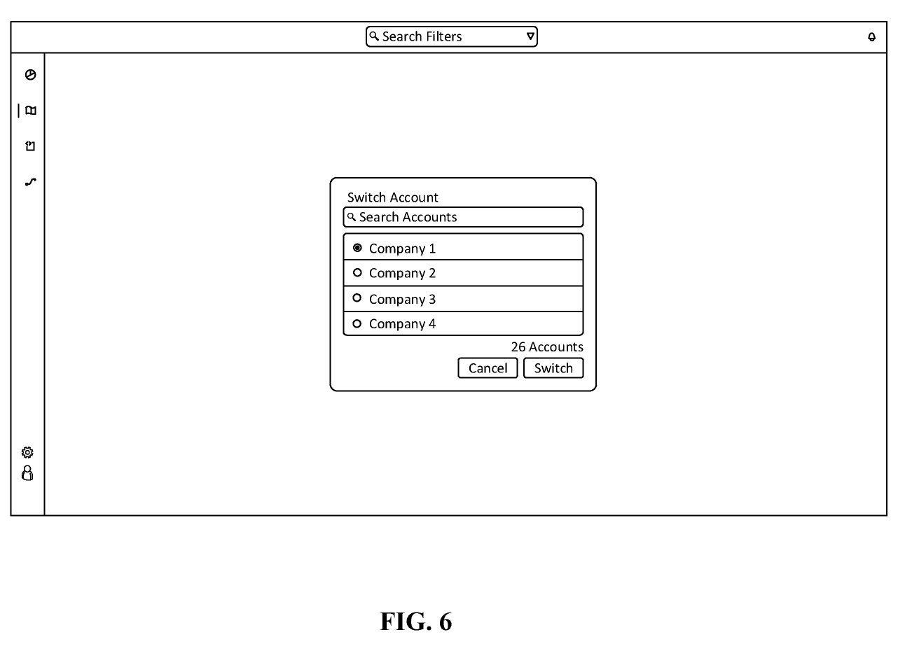

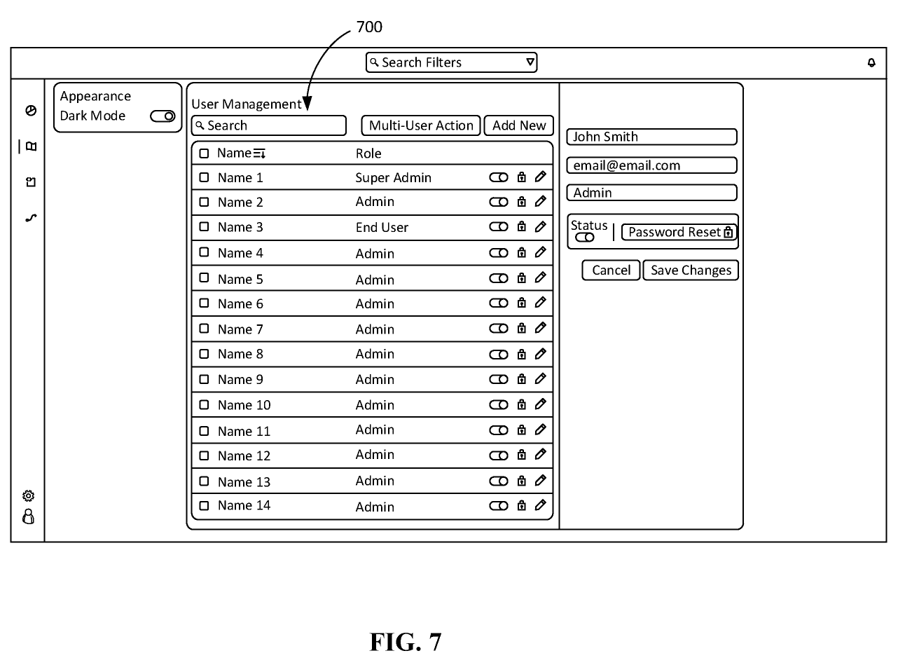

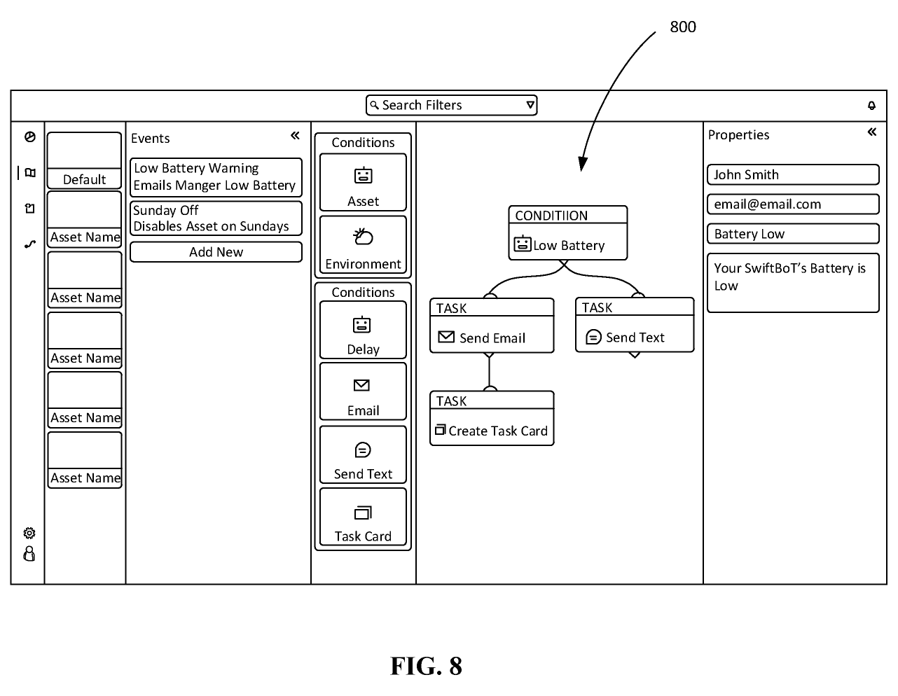

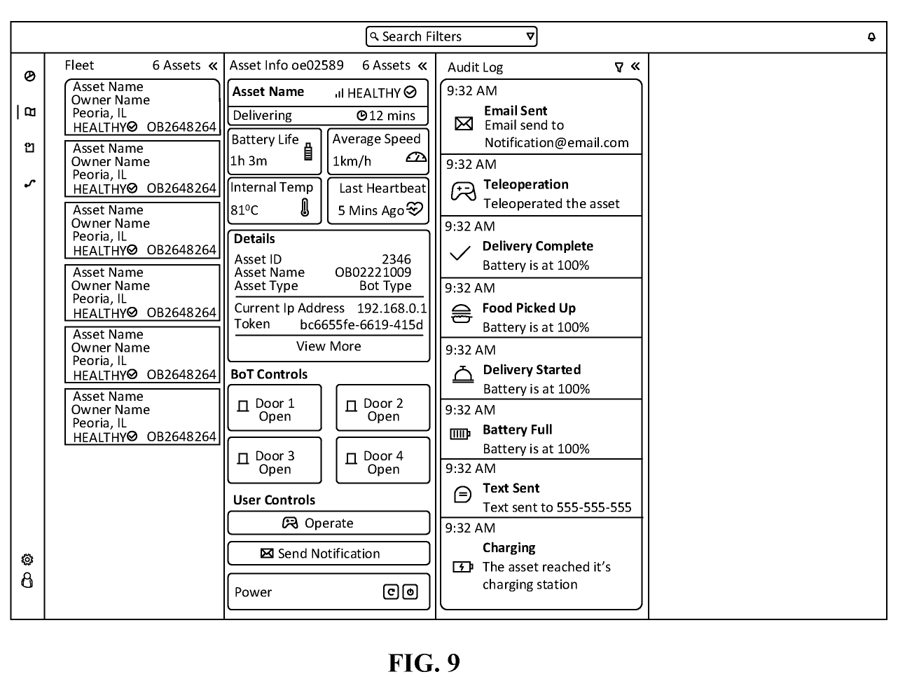

By maintaining and monitoring comprehensive logs of the operational status of a company’s electronic assets, triggering workflows to resolve or fix issues with such digital assets where the assets are detected to be performing below par or not performing at all, asset management systems proffer businesses with automated solutions to guarantee that the assets they own are constantly operational and fully optimized. With asset management systems, virtual operation of issues that would otherwise have required on ground technicians can be monitored remotely. For instance, detecting an ongoing fault in a company’s electronic asset may be made possible through the asset management system, following which, the system may trigger workflows around the stated problems. Asset management systems can be utilized in various industries where electronic assets are constantly engaged. In the service industry for instance, a business may possess a wide range of electronic assets from computing equipment to robotic assets and many more other electronic assets. Through an efficient asset management system, a business may be able to detect the precise location of an asset owned by the organization at all times. Via a graphical user interface, a business may be presented with operational data regarding their assets. The business may, through a graphical user interface, input instructions such as requesting a full diagnostic breakdown of the out-of-service asset, requesting a production of operational logs to determine the source of its fault amongst others. A business may further through an asset management system monitor and control access to and movements of assets. In today’s business world, there may be a core need for asset management systems that allow for efficient management and optimization of a business’ electronic assets. Businesses may save a lot of operational costs through the use of a proficient asset management system. Via the disclosed asset management system, core data information relevant to the operational status of an electronic asset such as battery life, internal temperature, last heartbeat (i.e. last active time stamp), workflow update, average performance indices may be presented to a business owner via a graphical user interface. By this, businesses are better positioned to overcome perceived inefficiencies of an electronic asset. The disclosed invention of an asset management system may be useful to the management of any electronic asset from which operational data may be retrieved such as smartphones, laptops, computers, robotic assets etc. Furthermore, through the asset management system, businesses may be able to manage a fleet of one or more different types of electronic assets. Through present disclosure, the data pooled from the electronic assets may be analyzed on a remote server, remote from the digital asset and transmitted to a human readable device for presentation to the end user via a graphical user interface. The reported data may be examined by the designated officials of the businesses that own the relevant digital asset such as technicians, operators, or any other officer tasked with the duties of ensuring the optimal performance of the digital assets. The disclosed asset management system is highly useful in ensuring the optimal usage and proper maintenance of electronic assets owned by organizations, more particularly automation of the asset management process. Graphical User Interfaces FIG. 5, 6, 7, 8 and 9 represent various depictions of the graphical user interface of an asset management system application. The asset management system user interface may be provided to a user via a processor on a human readable device in the example of FIG. 5, a representation of a graphical user interface of the log-in page of the asset management system is shown, providing a gateway for the user to access full functionalities of the asset management system. The user may bypass this gateway by inputting their user identification string which may be a unique username assigned to the user at the time of signing up for the application and unique password. The Asset management system may be configured to identify each marketplace user using their User Identification in conjunction with their password and each password may be unique to the identification string which it is assigned. The system may determine if the pair of the user identification string and the unique password are accurate and upon determining their accuracy, it may allow the user to full access to the functionalities of the asset management system. Organizations may create accounts with or without a fee on the asset management system allowing them access to the system’s functionalities. Upon the creation of an account, the organization may be assigned a unique identification string and a unique password for subsequently accessing the Asset management system and its functionalities. As shown in the example of FIG. 6. Technicians with access to accounts of different companies may be able to switch access between different organizations they belong to and access the asset management systems of these companies. FIG. 7 represents a depiction of a graphical user interface of a user management page of the disclosed asset management system. As shown in the example of FIG. 7 organizations may be able to view various levels of individuals within the organization that have access to the company’s asset management system accounts. By inputting a certain individual’s name within the organization in the filter bar 700, individuals with access to an organization’s asset management system account may be able to discover the level of access such an individual has to the asset management system account. In the example of FIG. 8, a representation of a graphical user interface of a task page of the disclosed asset management system is depicted. Via this page, organizations may be able to create task workflows 800 around various certain data values. As stated above, the asset management system may be configured to execute certain workflows upon the receipt of certain real time data values. As shown in the example of FIG. 8, the detection of a low battery data value may precipitate the execution of a workflow by the asset management system such as sending an email notification, SMS notification or creating a Trello®️ card to the designated recipient of such notifications on the organization’s asset management system account. FIG. 9 represents a depiction of a graphical user interface of a fleet page of the disclosed asset management system. Via the fleet page, organizations may be able to access the precise location of each of their assets. The Graphical user interface may provide outlays of maps showing the users of the Asset management system the precise location of the digital asset on the map. FIG. 9 depicts another representation of a graphical user interface of a fleet page of the disclosed asset management system. On the fleet page, users may be able to access a plurality of data values relating to the asset such as the battery life, the internal temperature, asset heartbeat update i.e. the last time the asset was functional along with other asset values. The asset may be further described in detail such as the asset type, asset ID, current IP address and any other asset information.

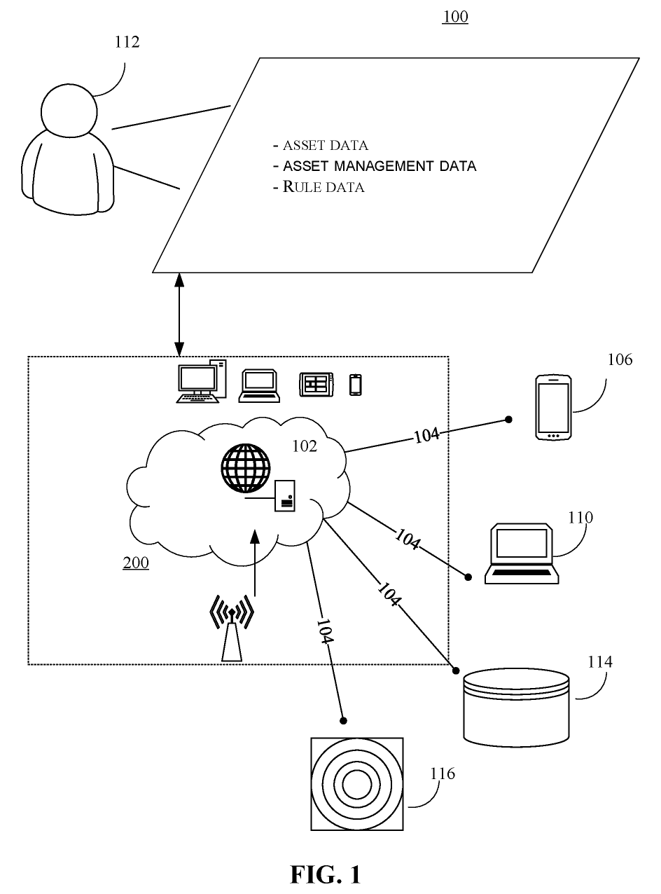

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

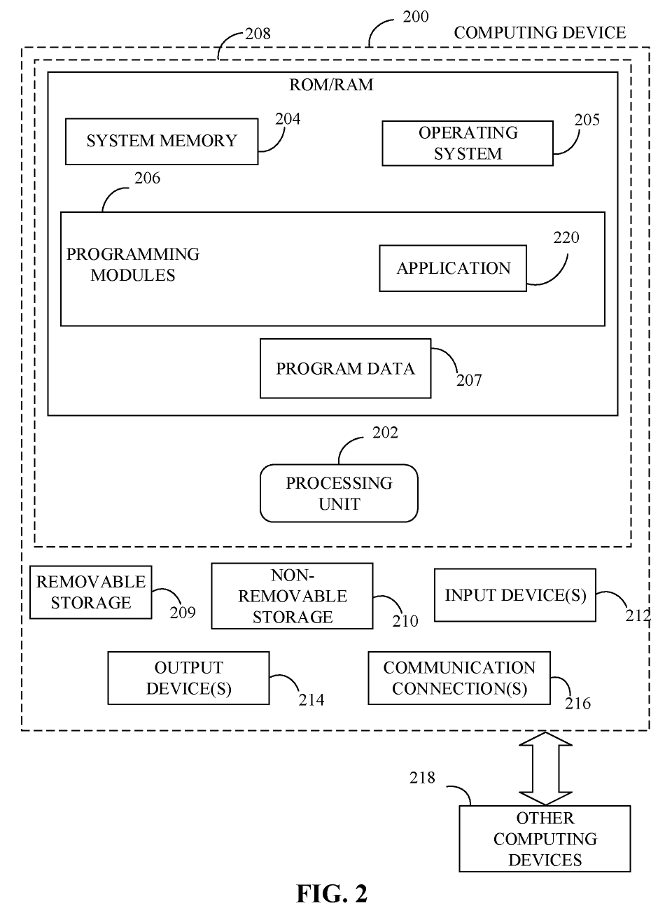

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

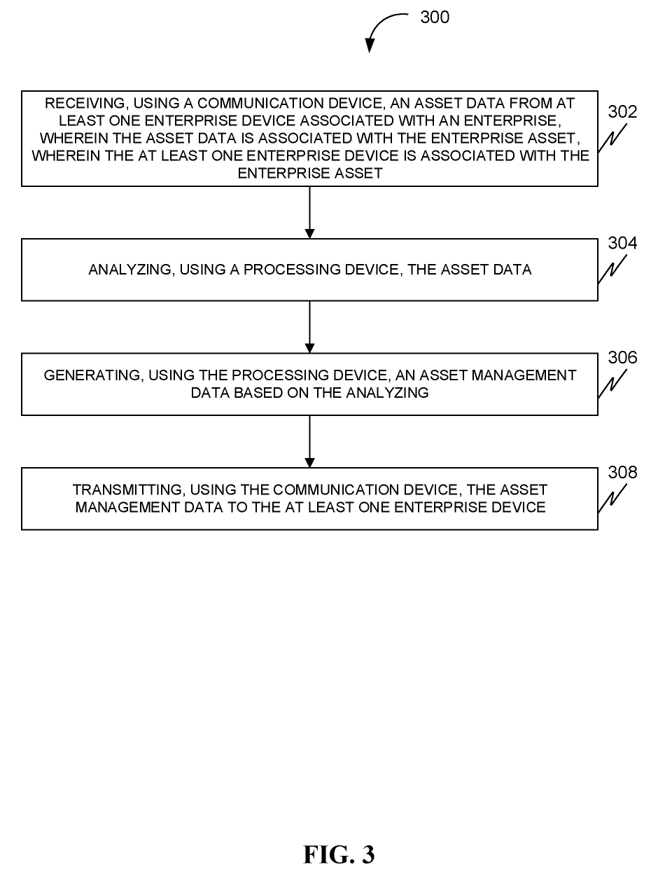

FIG. 3 illustrates a flowchart of a method 300 of managing an enterprise asset, in accordance with some embodiments.

Accordingly, the method 300 may include a step 302 of receiving, using a communication device 402, an asset data from one or more enterprise devices associated with an enterprise. Further, the asset data may be associated with the enterprise asset. Further, the one or more enterprise devices may be associated with the enterprise asset. Further, the method 300 may include a step 304 of analyzing, using a processing device 404, the asset data. Further, the method 300 may include a step 306 of generating, using the processing device 404, an asset management data based on the analyzing. Further, the method 300 may include a step 308 of transmitting, using the communication device 402, the asset management data to the one or more enterprise devices.

In some embodiments, the asset data includes an asset log data corresponding to an operation of the enterprise asset. Further, the asset log data includes a first asset log data corresponding to a first time duration and a second asset log data corresponding to a second time duration. Further, second time duration occurs later than the first time duration. Further, the asset management data includes an asset performance data corresponding to a performance analysis of the enterprise asset.

In some embodiments, the asset data includes each of a threshold data and one or more operational data corresponding to an operation of the enterprise asset. Further, the analyzing includes comparing the one or more operational data with the threshold data.

In some embodiments, the asset data includes a rule data representing a rule. Further, the asset data includes an operational data corresponding to an operation of the enterprise asset. Further, the asset management data includes a deviation data representing a deviation of the operation from an expected operation.

In some embodiments, the asset management data includes an asset maintenance data, an asset health data and an asset specification data. Further, the asset maintenance data corresponds to a maintenance operation associated with the enterprise asset, the asset health data corresponds to a current health status of the enterprise asset and the asset specification data represents a technical description of the enterprise asset.

In some embodiments, the asset management data includes a command data. Further, the command data corresponds to an operation associated with the enterprise asset. Further, the command data includes an asset optimization data corresponding to an instruction to optimize the operation. Further, the command data includes workflow trigger data representing an initiation of a sequence of tasks associated with one or more operations associated with the enterprise asset.

In some embodiments, the asset management data includes a geographic location data representing a geographic location of the enterprise asset.

In some embodiments, the asset data includes a user role data corresponding to a user associated with the enterprise, one or more of an employee name data corresponding to a name of an employee associated with the enterprise and an employee access level data corresponding to a level of access the employee may be allocated. Further, one or more of the generating and the transmitting may be based on the user role data.

In some embodiments, the asset management data includes a GUI data which may be configured to present a GUI on a display device of the one or more enterprise devices. Further, the GUI data includes an employee role data corresponding to a role assigned to an employee associated with the enterprise. Further, the GUI data includes an enterprise selection data corresponding to two or more enterprises. Further, the asset data includes a selection data corresponding to a selection of one or more of the two or more enterprises. Further, one or more of the generating and the transmitting may be based on the selection data.

In some embodiments, the asset data includes a sensor data. Further, the enterprise asset includes a robot. Further, the method 300 further includes receiving, using the communication device 402, a weather data from a weather service platform. Further, the asset management data includes a command data which may be configured to control the robot. Further, the generating of the command data may be further based on a rule data representing a rule based on the weather. Further, the asset data includes the rule data.

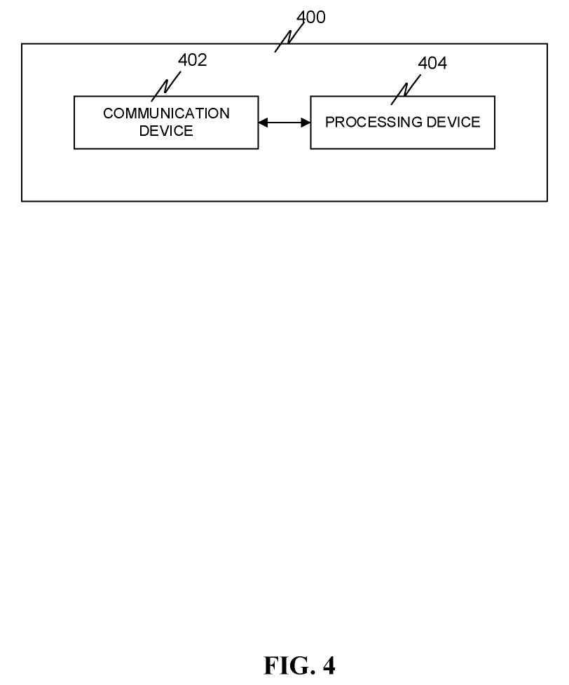

FIG. 4 illustrates a block diagram of a system 400 of managing an enterprise asset, in accordance with some embodiments.

Accordingly, the system 400 may include a communication device 402. Further, the communication device 402 may be configured for receiving an asset data from the one or more enterprise devices associated with an enterprise. Further, the asset data may be associated with the enterprise asset. Further, the one or more enterprise devices may be associated with the enterprise asset. Further, the communication device 402 may be configured for transmitting an asset management data to the at least one enterprise device. Further, the system 400 may include a processing device 404. Further, the processing device 404 may be configured for analyzing the asset data. Further, the processing device 404 may be configured for generating the asset management data based on the analyzing.

In some embodiments, the asset data includes an asset log data corresponding to an operation of the enterprise asset. Further, the asset log data includes a first asset log data corresponding to a first time duration and a second asset log data corresponding to a second time duration. Further, second time duration occurs later than the first time duration. Further, the asset management data includes an asset performance data corresponding to a performance analysis of the enterprise asset.

In some embodiments, the asset data includes each of a threshold data and one or more operational data corresponding to an operation of the enterprise asset. Further, the analyzing includes comparing the one or more operational data with the threshold data.

In some embodiments, the asset data includes a rule data representing a rule. Further, the asset data further includes an operational data corresponding to an operation of the enterprise asset. Further, the asset management data includes a deviation data representing a deviation of the operation from an expected operation.

In some embodiments, the asset management data includes an asset maintenance data, an asset health data and an asset specification data. Further, the asset maintenance data corresponds to a maintenance operation associated with the enterprise asset, the asset health data corresponds to a current health status of the enterprise asset and the asset specification data represents a technical description of the enterprise asset.

In some embodiments, the asset management data includes a command data. Further, the command data corresponds to an operation associated with the enterprise asset. Further, the command data includes an asset optimization data corresponding to an instruction to optimize the operation. Further, the command data further includes workflow trigger data representing an initiation of a sequence of tasks associated with one or more operations associated with the enterprise asset.

In some embodiments, the asset management data includes a geographic location data representing a geographic location of the enterprise asset.

In some embodiments, the asset data includes a user role data corresponding to a user associated with the enterprise, one or more of an employee name data corresponding to a name of an employee associated with the enterprise and an employee access level data corresponding to a level of access the employee may be allocated. Further, one or more of the generating and the transmitting may be based on the user role data.

In some embodiments, the asset management data includes a GUI data which may be configured to present a GUI on a display device of the one or more enterprise devices. Further, the GUI data includes an employee role data corresponding to a role assigned to an employee associated with the enterprise. Further, the GUI data further includes an enterprise selection data corresponding to two or more enterprises. Further, the asset data includes a selection data corresponding to a selection of one or more of the two or more enterprises. Further, one or more of the generating and the transmitting may be based on the selection data.

In some embodiments, the asset data includes a sensor data. Further, the enterprise asset includes a robot. Further, the system 400 further includes receiving, using the communication device 402, a weather data from a weather service platform. Further, the asset management data includes a command data which may be configured to control the robot. Further, the generating of the command data may be further based on a rule data representing a rule based on the weather. Further, the asset data includes the rule data.

In some embodiments, the enterprise asset includes an electronic asset.

In some embodiments, the electronic asset includes two or more electronic assets.

In some embodiments, the electronic asset includes two or more asset types.

In some embodiments, the one or more enterprise devices includes a smartphone.

In some embodiments, the enterprise asset includes a robotic device.

In some embodiments, the one or more enterprise devices includes a laptop.

In some embodiments, the one or more enterprise devices includes a desktop.

In some embodiments, the method 300 may further include storing, using a storage device, the asset management data. Further, the asset management data stored can be recovered at a future time duration.

In some embodiments, storing may be based on a storage queue. Further, the storage queue may be a service to store and manage the asset management data.

In some embodiments, the asset performance data includes a below-par indication data representing poor performance of the enterprise asset.

In some embodiments, the asset performance data includes a null indication data representing least performance of the enterprise asset.

In some embodiments, the asset management data includes an alert data corresponding to an alert.

In some embodiments, the alert data includes an instructional data corresponding to an instruction to fix an issue associated with the enterprise asset.

In some embodiments, the generating of the alert data may be based on detecting, using the processing device 404, an anomaly in the asset data based on the analyzing. Further, the anomaly corresponds to a deviation in an enterprise device behavior.

In some embodiments, the anomaly further includes a low battery indication corresponding to lower battery state of one or more batteries associated with the one or more enterprise devices.

In some embodiments, the transmitting of the asset management data may be based on a SMS protocol.

In some embodiments, the transmitting of the asset management data may be based on one or more of an email protocol.

In some embodiments, the alert data further includes a task card data representing an instruction to address the alert.

In some embodiments, the asset health data includes a battery life data representing a time remaining until complete discharge of one or more batteries associated with the one or more enterprise devices.

In some embodiments, the asset health data includes an internal temperature data representing the working temperature level of internal components associated with the enterprise device.

In some embodiments, the asset health data includes a last heartbeat data. Further, the last heartbeat data includes a time data corresponding to a state of the enterprise asset.

In some embodiments, the state includes an active state corresponding to an enabled state of the enterprise asset.

In some embodiments, the state includes an operational state corresponding to a functional state of the enterprise asset.

In some embodiments, the state includes an inactive state corresponding to an unpowered state of the enterprise asset.

In some embodiments, the asset health data includes an average performance index data corresponding to the efficiency of the enterprise device.

In some embodiments, the asset management data includes a multi asset location data representing the geographic location of each of the enterprise asset within two or more enterprise assets associated with the enterprise.

In some embodiments, the command data includes an asset optimization data corresponding to an instruction to optimize the operation associated with the enterprise asset.

In some embodiments, the command data includes a workflow trigger data representing an initiation of a sequence of tasks associated with one or more operations associated with the enterprise asset.

In some embodiments, the asset specification data further includes an asset type data corresponding to a category of the enterprise asset.

In some embodiments, the asset specification data further includes an asset ID corresponding to an identification number associated with the enterprise asset allocated by an asset manufacturer.

In some embodiments, the asset specification data further includes an asset IP corresponding to a numeric address associated with the enterprise asset.

In some embodiments, the user further includes one or more of a technician and an operator.

In some embodiments, the user role data further includes one or more of a user id and a password associated with the user id. Further, the analyzing may be further based on each of the user id and the password.

In some embodiments, the one or more enterprise devices includes a technician device, corresponding to a technician in charge of a maintenance operation associated with the enterprise asset.

In some embodiments, the technician device may be located at an individual location.

In some embodiments, the asset data includes an enterprise identification data associated with the enterprise. Further, one or more of the generating and the transmitting may be based on the enterprise identification data.

In some embodiments, the enterprise identification data further includes one or more of an enterprise id and a password associated with the enterprise id. Further, the analyzing may be further based on each of the enterprise id and the password.

In some embodiments, the method 300 may further include transmitting, using the communication device 402, a query data to the one or more enterprise devices. Further, the asset data may be received in response to the query data.

In some embodiments, the query data includes an API call data representing a request to an API associated with the enterprise asset.

In some embodiments, the communication device 402 performs each of the receiving and the transmitting based on a communication protocol comprising one or more of a HTTP, a websocket and a MQTT.

In some embodiments, the GUI data includes a workflow presentation data representing an operation associated with the one or more enterprise devices.

Although the invention has been explained in relation to its preferred embodiment, it is to be understood that many other possible modifications and variations can be made without departing from the spirit and scope of the invention as hereinafter claimed.

1. A method of managing an enterprise asset, the method comprising:
receiving, using a communication device, an asset data from at least one enterprise device associated with an enterprise, wherein the asset data is associated with the enterprise asset, wherein the at least one enterprise device is associated with the enterprise asset;
analyzing, using a processing device, the asset data;
generating, using the processing device, an asset management data based on the analyzing; and
transmitting, using the communication device, the asset management data to the at least one enterprise device.

2. The method of claim 1, wherein the asset data comprises an asset log data corresponding to an operation of the enterprise asset, wherein the asset log data comprises a first asset log data corresponding to a first time duration and a second asset log data corresponding to a second time duration, wherein second time duration occurs later than the first time duration, wherein the asset management data comprises an asset performance data corresponding to a performance analysis of the enterprise asset.

3. The method of claim 1, wherein the asset data comprises each of a threshold data and at least one operational data corresponding to an operation of the enterprise asset, wherein the analyzing comprises comparing the at least one operational data with the threshold data.

4. The method of claim 1, wherein the asset data comprises a rule data representing a rule, wherein the asset data further comprises an operational data corresponding to an operation of the enterprise asset, wherein the asset management data comprises a deviation data representing a deviation of the operation from an expected operation.

5. The method of claim 1, wherein the asset management data comprises an asset maintenance data, an asset health data and an asset specification data, wherein the asset maintenance data corresponds to a maintenance operation associated with the enterprise asset, the asset health data corresponds to a current health status of the enterprise asset and the asset specification data represents a technical description of the enterprise asset.

6. The method of claim 1, wherein the asset management data comprises a command data, wherein the command data corresponds to an operation associated with the enterprise asset, wherein the command data comprises an asset optimization data corresponding to an instruction to optimize the operation, wherein the command data further comprises workflow trigger data representing an initiation of a sequence of tasks associated with at least one operation associated with the enterprise asset.

7. The method of claim 1, wherein the asset management data comprises a geographic location data representing a geographic location of the enterprise asset.

8. The method of claim 1, wherein the asset data comprises a user role data corresponding to a user associated with the enterprise, at least one of an employee name data corresponding to a name of an employee associated with the enterprise and an employee access level data corresponding to a level of access the employee is allocated, wherein at least one of the generating and the transmitting is based on the user role data.

9. The method of claim 1, wherein the asset management data comprises a GUI data configured to present a GUI on a display device of the at least one enterprise device, wherein the GUI data comprises an employee role data corresponding to a role assigned to an employee associated with the enterprise, wherein the GUI data further comprises an enterprise selection data corresponding to a plurality of enterprises, wherein the asset data comprises a selection data corresponding to a selection of one or more of the plurality of enterprises, wherein at least one of the generating and the transmitting is based on the selection data.

10. The method of claim 1, wherein the asset data comprises a sensor data, wherein the enterprise asset comprises a robot, wherein the method further comprises receiving, using the communication device, a weather data from a weather service platform, wherein the asset management data comprises a command data configured to control the robot, wherein the generating of the command data is further based on a rule data representing a rule based on the weather, wherein the asset data comprises the rule data.

11. A system of managing an enterprise asset, the system comprising:
a communication device configured for:
receiving an asset data from the at least one enterprise device associated with an enterprise, wherein the asset data is associated with the enterprise asset, wherein the at least one enterprise device is associated with the enterprise asset; and
transmitting an asset management data to the at least one enterprise
device; and
a processing device configured for:
analyzing the asset data; and
generating the asset management data based on the analyzing.

12. The system of claim 1, wherein the asset data comprises an asset log data corresponding to an operation of the enterprise asset, wherein the asset log data comprises a first asset log data corresponding to a first time duration and a second asset log data corresponding to a second time duration, wherein second time duration occurs later than the first time duration, wherein the asset management data comprises an asset performance data corresponding to a performance analysis of the enterprise asset.

13. The system of claim 1, wherein the asset data comprises each of a threshold data and at least one operational data corresponding to an operation of the enterprise asset, wherein the analyzing comprises comparing the at least one operational data with the threshold data.

14. The system of claim 1, wherein the asset data comprises a rule data representing a rule, wherein the asset data further comprises an operational data corresponding to an operation of the enterprise asset, wherein the asset management data comprises a deviation data representing a deviation of the operation from an expected operation.

15. The system of claim 1, wherein the asset management data comprises an asset maintenance data, an asset health data and an asset specification data, wherein the asset maintenance data corresponds to a maintenance operation associated with the enterprise asset, the asset health data corresponds to a current health status of the enterprise asset and the asset specification data represents a technical description of the enterprise asset.

16. The system of claim 1, wherein the asset management data comprises a command data, wherein the command data corresponds to an operation associated with the enterprise asset, wherein the command data comprises an asset optimization data corresponding to an instruction to optimize the operation, wherein the command data further comprises workflow trigger data representing an initiation of a sequence of tasks associated with at least one operation associated with the enterprise asset.

17. The system of claim 1, wherein the asset management data comprises a geographic location data representing a geographic location of the enterprise asset.

18. The system of claim 1, wherein the asset data comprises a user role data corresponding to a user associated with the enterprise, at least one of an employee name data corresponding to a name of an employee associated with the enterprise and an employee access level data corresponding to a level of access the employee is allocated, wherein at least one of the generating and the transmitting is based on the user role data.

19. The system of claim 1, wherein the asset management data comprises a GUI data configured to present a GUI on a display device of the at least one enterprise device, wherein the GUI data comprises an employee role data corresponding to a role assigned to an employee associated with the enterprise, wherein the GUI data further comprises an enterprise selection data corresponding to a plurality of enterprises, wherein the asset data comprises a selection data corresponding to a selection of one or more of the plurality of enterprises, wherein at least one of the generating and the transmitting is based on the selection data.

20. The system of claim 1, wherein the asset data comprises a sensor data, wherein the enterprise asset comprises a robot, wherein the system further comprises receiving, using the communication device, a weather data from a weather service platform, wherein the asset management data comprises a command data configured to control the robot, wherein the generating of the command data is further based on a rule data representing a rule based on the weather, wherein the asset data comprises the rule data.
